(19) United States
(12) Patent Application Publication
(10) Pub. No.: US 2010/0198643 A1
(43) Pub. Date: Aug. 5, 2010

(54) DRINKS MACHINE WITH NETWORK DRINK ORDERING

(76) Inventors: Ram Friedman, Kfar Yona (IL); Shay Popper, Kfar Yona (IL); David Eisenman, Kfar Yona (IL); Micha Har-Zion, Kfar Yona (IL)

Correspondence Address: YORAM TSIVION, P.O. BOX 1307, PARDES HANNA, 37111, IL

(21) Appl. No.: 12/671,833

(22) PCT Filed: Aug. 3, 2008
(86) PCT No.: PCT/IB08/53100

§ 371 Date: Feb. 2, 2010

(30) Foreign Application Priority Data
Aug. 2, 2007 (GB) 0715044.4

(51) Int. Cl. G06Q 10/00; G05D 11/16; G05D 7/06; G06Q 30/00

(52) U.S. Cl. 705/8; 700/265; 705/27; 700/283; 700/285

(57) ABSTRACT

One or more drinks machines are used for preparing or providing drinks using a computers' network, and an adapter connected in between. The users can order drinks through a graphic interface and monitor the status of the drinks and of the machines. The orders can be managed using a queue and each user can be notified through the computer when the drink is ready or can he prepared. The adapter can he connected to an existing machine or provided with one. Another possibility is that the adapter would include wireless communication support. It may he possible that the adapter would also monitor the drink machine as well as sending commands for preparing ordered drinks.

The present application claims priority from the patent application No. GB0715044.4 filed in Great Britain on 2 Aug. 2007 by the present applicants and entitled “Computerized Online Drink Machine”.

CODM(™) is claimed as a trademark by the present applicants

### TECHNICAL FIELD

This invention relates to drinks machines computer controlled from a remote location and to methods for their operation.

### BACKGROUND ART

In many places such as companies or businesses or at home, there is a coffee machine and/or a drink machine, for the use of workers, visitors or other users. Such machines allow for each user to prepare or select a desired drink. Drinks machines may be found in public places, at movies, malls, at home, etc.

Whereas such machines provide drinks efficiently and save employees' or users' time, there are still problems to be solved and there is room for improvement.

For example, when a certain drink or ingredient runs out, the desired drink may not be provided. Several users waiting for their drinks would form a waiting line in front of the machine, which may irritate other users and may waste precious working time. If the machine is broken down or depleted of some ingredients, users will have to occasionally go and check the status of the machine.

Employees at a conference desiring to make a coffee break, may have to waste precious time to go to the drinks machine, to select and prepare drinks.

While in many organizations and companies there is a local area network, a wireless network or any other computer network, such prior art networks do not provide control over the local drinks machine. For example, a cellular wireless network may be used.

Thus, the status of the machine and availability of drinks may not be known, this may cause a waste of time and energy of workers and visitors for getting their drinks.

Prior art systems which the applicants believe to be different from the present invention include:

United States Patent Application 20030158624; Kimura, Shuji Aug. 21, 2003 Service provision support system, server and computer program.

WO 01/39468 A1; Mobile Telephone Networks Prop; VENDING MACHINE SYSTEM USING MOBILE PHONE AND METHOD THEREOF

WO 2007/015610 A1; Baek Sang-Ju.

U.S. Pat. No. 6,764,003 Martschitsch et al. Jul. 20, 2004;

Transaction method and selling system

JP2002056443 Nippon Electric Co.

System and a method of selling merchandises of an automatic vending machine for providing merchandises to users

JP 2002298203 Mitsubishi;

Vending machine enabling only a purchaser having a purchase qualification to purchase without halting the vending machine for selling an item with sales restriction.

Comtech telemetry solutions: Vending telemetry offers remote monitoring via the Internet.

### DISCLOSURE OF INVENTION

According to the present invention, there is provided a Computerized Online Drinks Machine, which will be referred to as CODM™.

The CODM may be connected to a local area network, wireless network, cellular or any other computer network in the business or at home, to provide data and/or control over the local drinks machine.

Thus, the drinks machine is controlled by the user requiring a drink, from a remote location. The machine can report its status to the user: drinks available, work in progress. etc.

### Definition of Terms

Throughout the present disclosure:

1. CODM—the new system, parts of the system and methods for system operation and use

2. Computer—a personal computer (PC), PDA, laptop computer mobile phone, etc.

3. Network—any means for connecting one or more computers to one or more drinks machines. A network may be wired or wireless

4. Drink—any combination or mixture using existing ingredients/materials in the drinks machine, at any desired temperature

5. Adapter—software and/or hardware means for translating a user's computer commands to operations performed in the drinks machine and vice versa.

6. Wireless—any wireless means for connecting parts of the network, including but not limited to radio frequency (RF) waves, laser, infrared, ultrasound, ultraviolet, etc.

Workers or visitors may access the coffee/drinks machine from their personal computer through the network, to order a desired drink easily and efficiently. When the drink is ready, the user will go to the machine to pick it up. The personal computer may use any control system such as a PDA, a cellular phone with the required capabilities, a laptop, etc.

The new system will enable a user, without having to actually go to the machine, to check whether the drink and the desired ingredients are available and to confirm that the machine is indeed working.

When a certain drink or ingredient runs out, it can be seen on the computer without having to step out of the room. As soon as the ingredient or drink is placed in the machine, it can be known through the network as well. A pop-up message may inform the user her drink is ready. An SMS message may be used to that purpose, a voice message, etc.

The users will not have to wait for drinks which are unavailable, and the possible waiting line in front of the machine will be reduced or eliminated altogether. The workers' waste of time relating to preparing drinks will be reduced, to make better use of employees' time.

If there is a machine failure, checking the machine status from a remote location may save the time and effort to check the machine locally. The drinks machine may automatically send messages to maintenance teams.

Workers at a conference in the office, and wish to make a coffee break, need not explain to a secretary what drinks they would like to have, but can simply select the drinks and verify their availability from a computer in their room.

The present invention relates to a remotely controlled drinks machine. There are various implementations of the invention, for example:

1. A system comprising a drinks machine connected to, and controlled from, a computer at another location (one to one).

2. A system comprising a drinks machine connected to, and controlled from, a plurality of computers at other locations (many to one). The drinks machine and computers may be connected in a local network, wired and/or wireless.

3. A system comprising a plurality of drinks machines connected to, and controlled from, a plurality of computers at other locations (many to many). The drinks machines and computers may be connected in a local network, wired and/or wireless.

4. A drinks machine including interface means for connecting to a remote computer, and means for enabling the machine to be controlled from the remote computer.

5. Interface means for a drinks machine, attachable to an existing prior art drinks machine for converting it into a machine capable of connecting to, and being controlled from, a remote computer.

6. A drinks machine locally connected to a personal computer.

Thus, the CODM may be implemented using an existing drinks machine, which can be connected to the network, or a new machine which is communications compatible.

The CODM may include software and/or a driver to be installed in the computers. Accordingly, the CODM may function similarly to a shared device of the network, such as a printer.

### BRIEF DESCRIPTION OF DRAWINGS

Preferred embodiments of the invention will now be described by way of example and with reference to the accompanying drawings, in which:

FIG. 1 shows drinks machines connected to a local computers network

FIG. 2 shows an interactive menu for a drinks machine

FIG. 3 describes a multipurpose adapter for a drinks machine

FIG. 4 describes in a flow chart the operation of the drinks machine system

FIGS. 5A and 5B detail a multi-purpose adapter and the components of the drinks machine

FIG. 6 describes in a flow chart a method for ordering drinks from a drinks machine

FIG. 7 describes in a flow chart a method in a drinks machine for receiving orders for drinks from a user.

### MODE FOR CARRYING OUT THE INVENTION

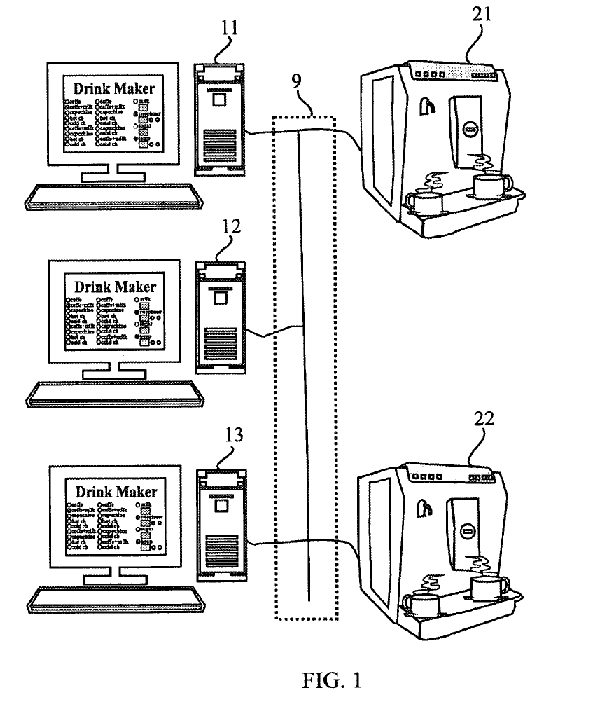

Referring to FIG. 1, one or more drinks machines 21 or 22 may be connected to one or more computers 11, 12 and 13 by local computers' network 9, which enables remote access to the drinks machine.

Workers or other users, may use the computers 11, 12 and 13 to access one or more of the drinks machines 21 or 22, in order to check their status, drinks' availability and may optionally ask to order and/or prepare drinks as well.

### System Description

a. An automatic drinks machine stores the provisions required for preparing various types of drinks, hot or cold. The desired drink, as selected by a user, is prepared under computer control, using the required ingredients/materials and according to predefined routines/recipes.

b. A computer program in a user's computer enables to open a window there to easily select a desired drink and to order it from a remote drinks machine.

The drinks ordering program may be activated without disrupting work in progress in that user's computer.

c. The system can store, for a multitude of users, each user's drinks preferences. For example, Ron may desire hot tea in the morning, cold Coke at noon and Cappuccino in the evening. Each user can order the usual or can modify it as desired. A different menu may be stored for, and displayed to, each user.

d. Each new drink ordered or menu entered may be stored in the system, together with its relation to a specific user who originated it.

e. The drinks machine may be defined as a hardware item in the user's computer, and may be selected to be installed there. Optionally, automatic installation of the hardware driver may be possible.

f. The drinks machine may also connect to support/maintenance providers. For example, when there is a failure, maintenance personnel may be automatically notified by a message sent them from the drinks machine. Moreover, when the machine is low on coffee, sugar, tea or any other material or ingredient, maintenance people or a service provider may be automatically notified.

The network 9 may preferably comprise a local area network, such as the one used in businesses and factories, or may comprise a wireless network, such as wireless LAN. The drinks machines 21 and/or 22 may be accessed wirelessly. Alternately, the computers and drinks machines may be connected through the Internet or an intranet.

In one embodiment, a graphic human-machine interface (HMI) allows easy access and control of the machine.

The graphic interface software can be provided from a computer in the network, either using software installed in each computer and/or having means for providing such an interface at the CODM.
In a preferred embodiment, it may be possible to check in advance, what drinks there are in each drinks machine and to order them from a specific CODM.

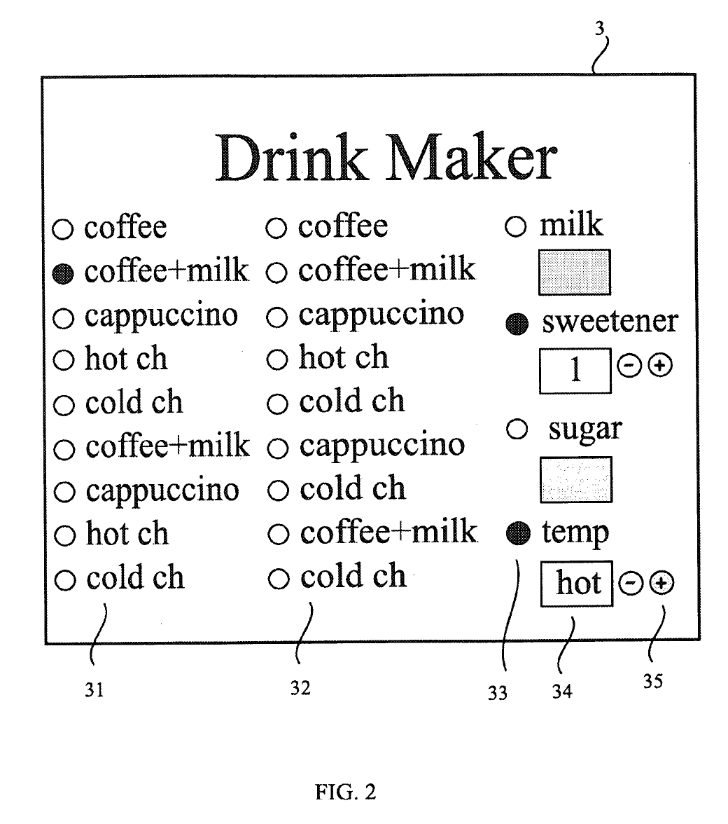

The graphic interface or interactive menu 3 can be implemented as shown in FIG. 2, in which available beverages are displayed 31, 32, such as types of hot or cold drinks of the drinks machine.

The method of operation of the drinks machine can be selected as well 33, such as the temperature 34 of the drink, how much milk should be poured, specification for sugar and/or sweetener usage, etc.

The above menu is just one example of a possible implementation. Various other drinks may be included, as well as their characteristics, such as the quantity of drink, how strong should be the drink, etc.

An open menu may be implemented, which may be edited by the user.

There are various implementations of the invention, for example (see FIG. 1):

1. A system comprising a drinks machine 21 connected to, and controlled from. a computer 11 at another location (one to one).

One user, when desiring a drink, connects from his/her computer 11 to a drinks machine 21 at a remote location, checks the status of the machine and places an order. The user then goes to the machine to pick up the order, when ready.

2. A system comprising a drinks machine 21 connected to, and controlled from, a plurality of computers 11, 12, 13 . . . at other locations (many to one). The drinks machine and computers may be connected in a local network 9, wired and/or wireless.

A plurality of users, each from his/her rooms (or from any convenient location they may happen to be when ordering the drink), each can access a remote drinks machine to order drinks there.

3. A system comprising a plurality of drinks machines 21, 22 . . . connected to, and controlled from, a plurality of computers 11, 12, 13 . . . at other locations (many to many). The drinks machines and computers may be connected in a local network 9, wired and/or wireless.

In this embodiments, there may be a plurality of drinks machines. Each user may check the status of each machine, prior to deciding where to place their order. For example, one machine may be too busy, with a long waiting line. Another machine may not have a desired drink available at a given moment, etc. This system structure allows to make better use of several drinks machines, with orders being placed to provide better service to all users.

Network implementation of systems (2) or (3) above: either a distributed network, or a server-based network. In the latter case, the system control method is implemented with software installed in the server. The server may support a multi-user environment including a plurality of machines and users.

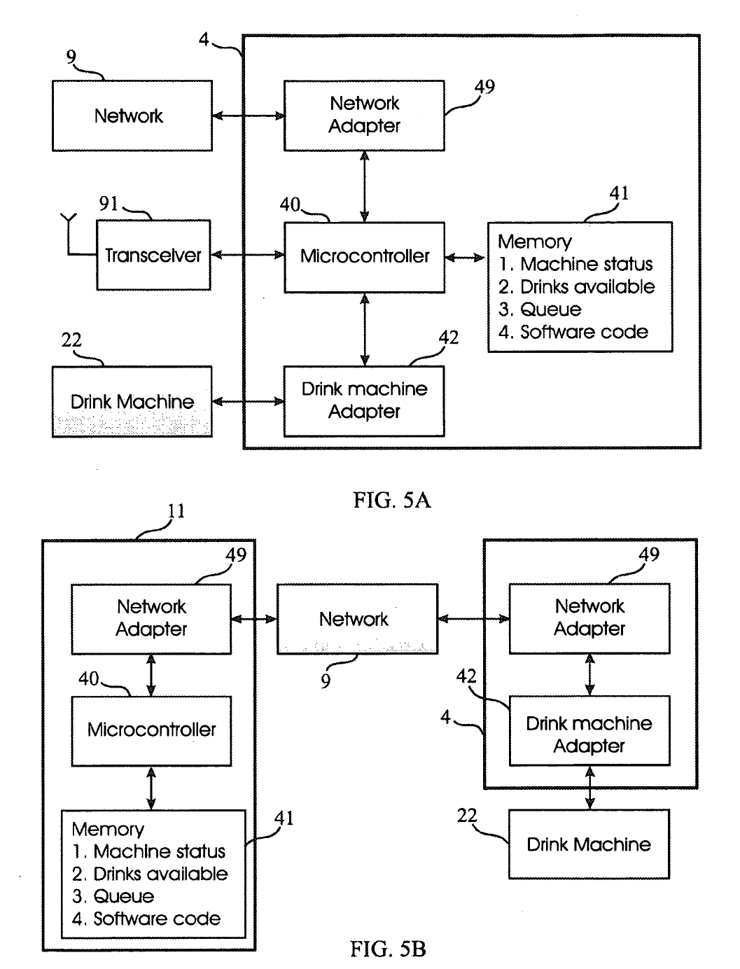

4. A drinks machine 22 including a multi-purpose adapter/interface means 4 (FIGS. 5A, 5B) for connecting to a remote computer 11, and means for enabling the machine to be controlled from the remote computer 11.

The adapter is integrated within the drinks machine.
This is the building block for implementing the structures (1) to (3) above, that is a drinking machine capable of being remotely controlled by users.

The present invention discloses, inter alia, a drinks machine which is remotely controlled, in conjunction with a method (computer program) for controlling the drinks machine from a remote location.

5. Interface means 4 for a drinks machine 22 (FIGS. 5A, 5B), attachable to an existing prior art drinks machine for converting it into a machine capable of connecting to, and being controlled from, a remote computer 11.

There are a multitude of drinks machines now in use, it would be desirable to convert them to be used in the new system.
By adding a conversion kit to prior art machines, it may be possible to enhance them to implement the functionality of the building block (4) above, for implementing the structures (1) to (3) above.

6. A drinks machine locally connected to a personal computer. In this embodiment, there is no network and the machine is controlled locally, rather than from a remote location.

### Method of Operation

1. The CODM software allows a user to switch, while routinely working at the computer, to a CODM window where a list of default available drinks are presented, and to choose, i.e. by mouse clicks, one drink to order.

2. If there are several drinks machines, the user will be given the option to select one machine to order from.

3. The user's selection will be transmitted to the drinks machine.

4. If there are problems, an adequate response will be returned to user and will be displayed in the CODM window.

5. When the drink is ready, the user will be so notified.

6. The user may modify any of the default recipes or build a new one, according to his taste, or to add one from an auxiliary source (such as a disk or the Internet), and to add it to his favorites library.

**End of method**

The drinks machine can provide hot or cold drinks, such as: Tea, Coffee, Cappuccino, Cocoa, Espresso, Cola, etc. For each drink, preferences may be set as detailed in FIG. 2, including for example the amount of milk, sugar or sweetener, temperature, etc.

Options menus 35, may include plus and minus controls for switching between options, dropdown menus and so forth.

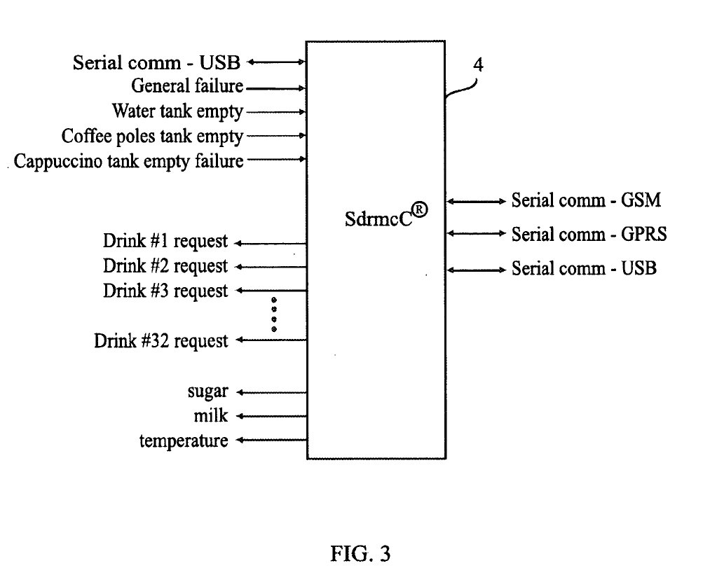

A multipurpose adapter 4 (see FIG. 3) for drinks machines can translate network, USB and/or any other computer-based bus commands to drinks machine signals, either in one direction or bi-directionally. The adapter can support commands similar to those of a printer, allowing computers of the network to order a drink.

The adapter 4 may be an integral part of a new drinks machine, to implement the new building block (4) detailed above.

Alternately, a suitable embodiment of adapter 4 may be installed in prior art, locally controlled drinks machines to convert them to the new machine, this is the interface detailed in embodiment (5) above.

The new drinks machine may include a personal computer or micro-computer or micro-controller for its operation. There are various implementations, depending on system requirements and system design, for example relating to the required complexity of the system, the maximal number of users and drinks machines supported in a network, speed of response, etc.

Once an order was placed, such as by using the graphic interface or interactive menu 3 of FIG. 2, a verification signal can be fed back, possibly with a serial number, a notice when the drink is ready or when is it supposed to be ready, such as according to the number of people waiting for their drink.

The adapter 4 may be connected and/or installed and/or embedded within and/or combined with a drinks machine. The adapter can check for the status of the machine and notify the users or a supervisor. Any indication or signal of the drinks machine can be monitored. This may include general or specific failure, water, coffee or any other tank being depleted, vocal or LED notification of the machine, etc.

Commands to the drinks machine, such as for preparing a specific drink, marked as a drink request, can be sent or any other indicative signal, such as the amount of sugar, milk desired drink temperature, etc.

The adapter can also support any type of communications, such as wireless communications including for example GSM or GPRS, for communicating directly with the drinks machine and/or with the computers either through a wireless network, or with one of the peripherals of the network.

The drinks machine can be connected using USB, if this protocol is supported. The drinks machine together with the adapter 4, may form the CODM system, allowing communicating with users and ordering drinks.

The adapter 4 connects to the drinks machine (on the left side of FIG. 3) and to a user's computer (on the right side). The signals to the drinks machine may be generally placed in two categories, a general purpose communication channel such as USB, and signals specific to the drinks machine such as “General failure”, “Sugar”, etc.

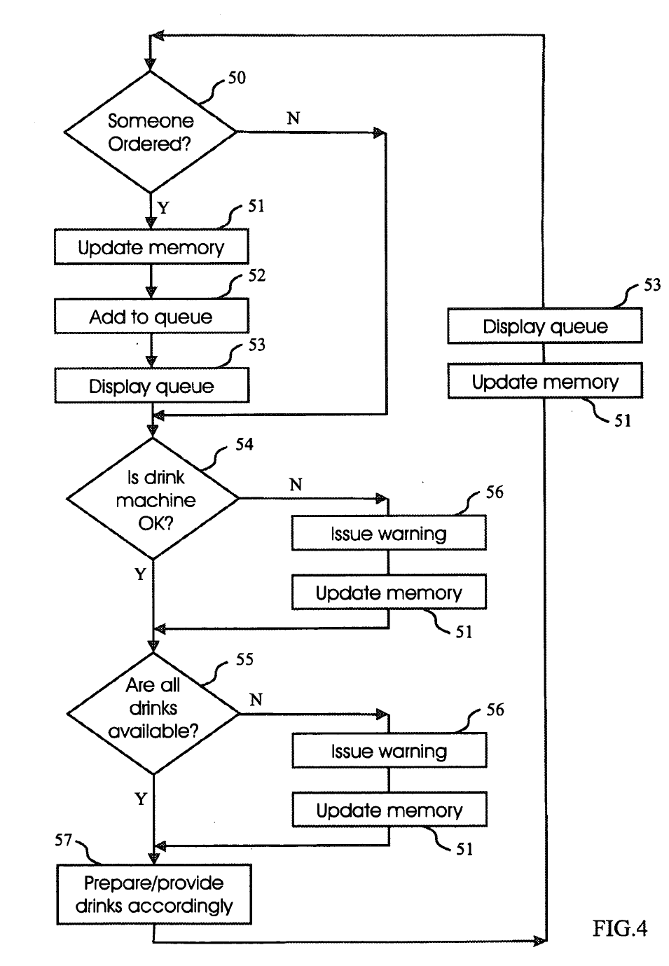

FIG. 4 describes, in a flow chart, one example of the operation of the drinks machine. The drinks machine can receive commands from one or more computers in a network.

As a user orders a drink 50, relevant data is updated in memory 51. This data can include the type of drink ordered, by whom, method of preparation, from which machine the drink was ordered if there is more than one machine, deletion of drinks which were already supplied, etc.

The person would be added to a queue 52, according to the time the drink was ordered. Each person could see the queue and order status 53, in order to see how many people are waiting for drinks at each machine (the order status), and what drinks are available. This option may also be accessed prior to ordering the drink, such as by a graphic interface.

It is possible to check whether the drinks machine is okay 54, either constantly or as a drink is ordered or is about to be ordered. If there is a problem with the drinks machine, a warning can be issued 56, to the machine administrator, to an outside contractor, to a secretary, and/or a general warning can be displayed to all the people who access the machine through the graphic interface.

Persons responsible for the machines maintenance may receive continuous status reports/information, no matter whether the machine is located nearby or at a remote location. When the machine runs low on an ingredient, a request for a refill may be sent to maintenance.

The memory will be updated accordingly 51, as to what is the exact problem and can remind occasionally about the problem. A special warning can be provided if several people ordered drinks, which cannot be provided. It may also be required to check if all the drinks are available 55, preferably this can be done periodically or constantly. If a certain drink is missing or is about to run out, a warning 56 can be given and the memory 51 can be updated.

If the machine can prepare the drink 57, then it can be prepared according to a queue, or the person can be called to the machine. It may be possible that the machine would automatically prepare the drink, and the person would go to the machine after the drink is ready. The memory will be updated 51 regarding the status of prepared drinks and the queue will be updated and displayed 53 accordingly.

A secretary can be notified about prepared drinks and to whom to supply them, allowing to deliver the drinks to users, who need not leave the office for receiving their drinks.

The CODM/Multi-purpose adapter 4 in FIG. 5A may connect to the network using a network adapter 49. This may be implemented within a chip and may support a standard network communication protocol, for accessing other computers and/or drinks machines.

The CODM can include a microcontroller 40 or similar/equivalent control logic. for accessing memory means 41, communicating with the network through the network adapter 49, and taking and/or sending commands to the drinks machine 22, using drinks machine adapter 42.

The CODM may be designed to support more than one protocol, such as having wire network interface and optionally using wireless communication protocols, such as using a wireless transceiver 91 and/or modem.

The memory 41 may include software and setup means for relevant drinks machines.

It may be possible to provide additional data, in order to allow reading commands from the drinks machine and sending commands to the drinks machine through the adapter 42. The status of the machines, the number and preferences of drinks prepared can be kept in the memory 41 as well, for managing the drinks machine 22 efficiently.

Drinks can be prepared according to their availability and placement in a queue, thus the first drink in the queue that can be prepared would be prepared, and then deleted from queue—after notification is provided that the drink is ready.

The microcontroller 40 can update relevant computers through the network adapter 49, about drinks availability, about the machine's status and about the queue's status.

Using the network adapter 49 or the transceiver means 91, it may be possible to emulate the CODM as a standard device of the network, such as a printer. This may be done with or without a driver installed in relevant computers.

Another possible embodiment of the CODM 4 is detailed in FIG. 5B, in which some of the components may be implemented in one or more computers 11 connected to the network 9.

In this embodiment, the CODM 4 may include adapter means for the network 49 and adapter means for the drinks machine 42, enabling a simpler implementation.

Network adapters means 49, may be present in computer 11, and in all the computers of the network 9. The microcontroller 40 of the computer 11 can be used for operating the CODM 4 through the network 9.

The computer's 11 memory 41, can be used for the CODM needs, saving the need for additional memory means in the CODM.
Thus, other computers in the network can order drinks from computer 11, which can communicate with the CODM, or it may be possible that all relevant computers will be compatible to communicate with the CODM, using their means similarly to that used for computer 11.

Thus, using a relevant software in one or more computers 11, it may be possible to implement the embodiment described in FIG. 5B, using less hardware resources in the CODM and possibly controlling and/or managing one or more drinks machines by one computer 11.

In another embodiment, the CODM includes means for receiving or loading therein its operating software. The software may be available on the Internet, for example. Software provided by a third party may be used.

Method for Ordering Drinks from a Drinks Machine

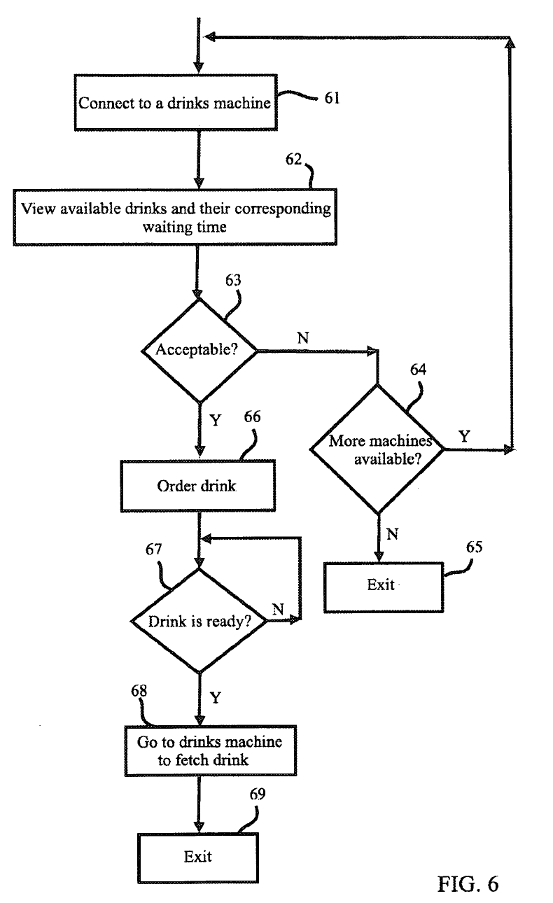

FIG. 6 describes in a flow chart a method for ordering drinks from a drinks machine, including:

a. Connect to a Drinks Machine 61

A user in the system may connect to the drinks machine using his personal computer or another device such as a laptop. The computer is connected through a communication channel to the drinks machine.

b. View Available Drinks and their Corresponding Waiting Time 62

After his machine has sent an inquiry to a drinks machine and received info: The user checks whether the drinks machine has available the drink he desires, and what is the waiting time for that drink. The machine may keep a queue of orders, and thus can predict the waiting time to fulfill this order. If that machine does not have the desired drink, or if the time in unacceptable, the user may check other drinks machines, if such machines are available and connected to the network.

c. Thus, the user can choose to order from a machine which meets his requirements. Alternatively, the user may place his order at another time, when the waiting list is shorter.

d. Acceptable? 63

That is, If a machine was found where an order can now be placed. If positive, goto [64] else goto [66].

e. More Machines Available? 64

if there are several drinks machines, the user can check them all, or those he considers conveniently close to his location.

f. Order Drink 66

A message is sent to the drinks machine, indicating the drink requested by that user. Preferably the message includes that user's identification, or some identification of the present order/transaction, to indicate, at the drinks machine, which drink belongs to whom.

g. Drink is Ready? 67

The user can review the status of the drinks machine, or the machine can send a message when the drink is ready.
Alternately, there is a parameter for each user: how much in advance to announce that user that the drink is ready. Thus, when the user actually arrives at the machine, the drink just gets ready—delivery just in time.

h. Go to Drinks Machine to Fetch Drink 68

The user goes to the machine to take his drink, without having to wait, even if there is a plurality of users waiting for their drinks.
This increases the productivity at the office, as time is not wasted waiting for the drinks machine.
**End of method**

### Method for Answering Users' Requests to a Drinks Machine

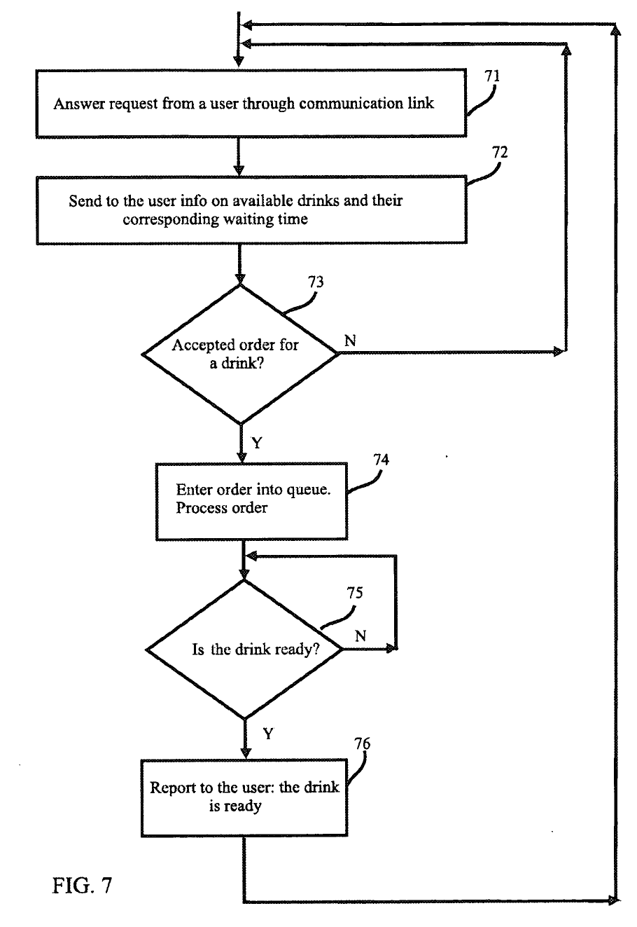

FIG. 7 describes in a flow chart a method in a drinks machine for receiving orders for drinks from a user, including:

a. Answer request from a user through communication link. 71 The system is so devised as to service users at remote locations.

b. Send to the user info on available drinks and their corresponding waiting time. 72

The drinks machine may be programmed to store the time it takes to prepare each type of drink. The machine stores a queue with orders in process (orders received and not yet delivered), so it can compute an evaluation of the waiting time for the present user.

The drinks machine may be programmed to store the waiting time for each user in the system.

b. Accepted Order for a Drink? 73

If the user chooses to order a drink, the got 74; else goto 71.

c. Enter order into queue. Process order. 74

d. Is the drink ready? 75

e. Report to the user: the drink is ready. 76

**End of method**

It will be recognized that the foregoing is but one example of a system and method within the scope of the present invention, and that various modifications will occur to those skilled in the art upon reading the disclosure set forth hereinbefore.

1. An adapter for a drink machine with network drink ordering, comprising:
means for connecting to the drink machine to read a status of the machine and for activating the drink machine to prepare a drink as ordered;
means for storing a plurality of requests for drinks and for activating the drink machine for preparing drinks responsive to the requests; and
means for connecting to at least one computer through a computer network, for sending to the computer information relating to requesting a drink, and for receiving a request for one or more drinks, wherein the received request is added to any pending requests for drinks and the computer information relating to requesting a drink is independent of a particular request, which is sent before a request is made to check the status of the drink machine.

2. The adapter according to claim 1, wherein the adapter is electronically connected to an existing drinks machine and to a local area network.

3. The adapter according to claim 1, wherein the adapter monitors the status and operation of the drinks machine and notifies one or more of the computers through the network.

4. The adapter according to claim 1, wherein the adapter further includes means for communicating with a graphic interface in one or more of the network's computers in order to receive requests for drinks, detailing required drinks and/or a method of operation of the drink machine.

5. The adapter according to claim 1, wherein the adapter further includes means for communicating with a graphic interface in one or more of the network's computers in order to present the machine status and-/or available drinks through the graphic interface.

6. The adapter according to claim 1, wherein the adapter further includes wireless communication means, for accessing the drink machine or the network or one or more computers.

7. The adapter according to claim 1, wherein the adapter is embedded in the drink machine.

8. The adapter according to claim 1, further including means for connecting more than one drink machines to the network so that the drink machines are accessible through the computers.

9. The adapter according to claim 1, further including means for reporting failures or sending a request for a refill to maintenance.

10. The adapter according to claim 1, further including means for connecting directly to a local personal computer rather than through a network.

11. The adapter according to claim 1, wherein the information relating to requesting a drink includes a presentation of a queue at each drinking machine, how many people are waiting for drinks at each machine and/or what drinks are available.

12. In an adapter for a drink machine with network drink ordering, a method of providing or preparing drinks, comprising:
connecting to the drink machine to read a status of the machine and to activate the drink machine to prepare a drink as ordered;
storing a plurality of requests for drinks to activate the drink machine to prepare drinks responsive to the requests; and
connecting to at least one computer through a computer network to send to the computer information relating to requesting a drink and to receive a request for one or more drinks, wherein the received request is added to any pending requests for drinks and the computer information relating to requesting a drink is independent of a particular request, which is sent before a request is made to check the status of the drink machine.

13. The method for providing or preparing drinks according to claim 12, further including:
checking and acquiring information about the drink machines' status and available drinks and ingredients; and
providing the information of step a to the computers through the network, and displaying the information to the users through the computers.

14. The method according to claim 12, further including:
taking orders from the users through the computers, based on available drinks and adding orders to queue; and
providing drinks according to order in queue and drinks and ingredients' availability.

15. The method according to claim 12, further including:
issuing warnings if there is a problem or there is about to be a problem with a drink machine, or if an ingredient runs out or is about to run out, or if it is not possible to provide an ordered drink.

16. The adapter according to claim 1, wherein the status of the machine includes at least one of the following: availability of drinks or desired ingredients; whether the machine is in working order or there is a failure; and whether the drink is ready.

17. The adapter according to claim 1, wherein the means for activating the drink machine to prepare a drink as ordered will control at least one of the following: the type of drink desired, ingredients and/or materials to be used in preparing the drink, drink temperature.

18. The adapter according to claim 1, wherein the information sent to the computer relating to requesting a drink comprises at least one of the following: status of the machine, waiting time for an order for drinks.

19. The adapter according to claim 1, further including means for emulating a standard device of the network.

20. The adapter for a drink machine according to claim 19, wherein the standard device of the network is a printer.
